(19) United States
(12) Patent Application Publication
(10) Pub. No.: US 2008/0154929 A1
(43) Pub. Date: Jun. 26, 2008

(54) COLLATION METHOD, REGISTRATION APPARATUS, COLLATION APPARATUS, AND PROGRAM

(76) Inventor: Hiroshi ABE, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/949,510

(22) Filed: Dec. 3, 2007

(30) Foreign Application Priority Data
Dec. 20, 2006 (JP) P2006-343588

(51) Int. Cl. G06F 7/04

(52) U.S. Cl. 707/101

(57) ABSTRACT

The present invention provides a collation method which, with respect to plural registered data stored in a storage medium, calculates first degrees of similarity among the data before starting the collation, and, of the plural registered data, calculates a second degree of similarity between one registered data selected as the collation subject and reference data to be collated with the one registered data, and, in case the second degree of similarity is not a degree of similarity that can authorize that a person is a registrant, of other registered data other than the one registered data, excluding registered data which is collated as the collation subject in the past, of the first degrees of similarity among the one registered data and other registered data, selects one registered data having a degree of similarity closest to the second degree of similarity as the next collation subject.

### CROSS REFERENCES TO RELATED APPLICATIONS

The present invention contains subject matter related to Japanese Patent Application JP2006-343588 filed in the Japanese Patent Office on Dec. 20, 2006, the entire contents of which being incorporated herein by reference.

### BACKGROUND OF THE INVENTION

1. Field of the Invention

This invention relates to a collation method, a registration apparatus, a collation apparatus, and a program which are desirably applied to the biometrics authentication.

2. Description of the Related Art

There is employed an apparatus which has stored therein biological patterns of a plurality of persons who satisfy a predetermined condition such as persons who are allowed to enter a predetermined place or persons who are allowed to use a predetermined personal computer as registered data, and authorizes that a person is a registrant in case the collation result (cross-correlation value) between one registered data selected from among thus stored plural registered data and reference data collated with the registered data is equal to or more than a threshold value.

Generally, this one registered data is selected in a random manner in series until the collation result (cross-correlation value) comes to be a predetermined threshold value or more.

On the other hand, in case the collation order in the plural registered data is selected in a random manner, the collation number of times may become large even if a person is a registrant. That is, the processing efficiency in case a person is a registrant is not stable.

To solve this problem, there is proposed one collation method which retains a plurality of reference images which are different from each other and first order data which represents the greatness of degree of similarity with registered images in descending order by making them correspond to the registered images for each registered image, and the collation order in registered images is determined based on the order correlation coefficient among the first order data, plural reference images, and second order data representing the greatness of degree of similarity of collation images in descending order (For example, Jpn. Pat. Appln. Laid-Open Publication No. 2006-139415).

### SUMMARY OF THE INVENTION

On the other hand, in this collation method, for each collation, the plural reference images and the second order data which represents the greatness of degree of similarity of collation images in descending order have to be generated, and the larger the number of registered images becomes, the longer the generation time period for the second order data becomes.

Accordingly, in this collation method, in case of exceeding a predetermined registration number, as compared with the case of randomly selecting the collation order in the plural registered data, there may be considered a situation in which the processing efficiency in case a person is a registrant becomes worse.

In view of the above-identified circumstances, it is therefore desirable to provide a collation method, a registration apparatus, a collation apparatus, and a program which can improve the processing efficiency in case a person is a registrant as compared with the case of randomly selecting the collation order in the plural registered data irrespective of the number of the registered data.

According to an embodiment of the present invention, there is provided a collation method including: a first step of, with respect to plural registered data stored in a storage medium, calculating first degrees of similarity among the data before stating the collation; a second step of, of the plural registered data, calculating a second degree of similarity between one registered data selected as the collation subject and reference data to be collated with the one registered data; and a third step of, in case the second degree of similarity is not a degree of similarity that can authorize that a person is a registrant, of other registered data other than the one registered data, excluding registered data which is collated as the collation subject in the past, of the first degrees of similarity among the one registered data and other registered data, selecting one registered data having a degree of similarity closest to the second degree of similarity as the next collation subject.

According to an embodiment of the present invention, there is also provided a registration apparatus including: a calculation unit that, with respect to plural registered data stored in a storage medium, calculates first degrees of similarity among the data as the selection criterion when one registered data is selected from among the plural registered data in a predetermined collation method, and a storage control unit that controls the storage medium such that the first degrees of similarity calculated by the calculation unit is stored in the storage medium.

According to an embodiment of the present invention, there is also provided a collation apparatus including: a calculation unit that, of the plural registered data stored in a storage medium, calculates a second degree of similarity between one registered data selected as the collation subject and reference data to be collated with the one registered data; and a selection unit that, in case the second degree of similarity is not a degree of similarity that can authorize that a person is a registrant, of other registered data other than the one registered data, excluding registered data which is collated as the collation subject in the past, among the first degrees of similarity between the plural registered data stored in the storage medium, of the first degrees of similarity among the one registered data and other registered data, selects one registered data having a degree of similarity closest to the second degree of similarity as the next collation subject.

According to an embodiment of the present invention, there is also provided a program that makes a computer execute the steps of: with respect to plural registered data stored in a storage medium, calculating first degrees of similarity among the data as selection criterion when one registered data is selected from among the plural registered data in a predetermined collation method; and controlling the storage medium such that the first degrees of similarity are stored in the storage medium.

According to an embodiment of the present invention, there is also provided a program that makes a computer execute the steps of: of the plural registered data stored in a storage medium, calculating a second degree of similarity between one registered data selected as the collation subject and reference data to be collated with the one registered data; and in case the second degree of similarity is not a degree of similarity that can authorize that a person is a registrant, of other registered data other than the one registered data, excluding registered data which is collated as the collation subject in the past, among the first degrees of similarity between the plural registered data stored in the storage medium, of the first degrees of similarity among the one registered data and other registered data, selecting one registered data having a degree of similarity closest to the second degree of similarity as the next collation subject.

According to the present invention, in case the reference data is assumed as the registered data, since registered data which is close to the degree of similarity with the reference data is selected as the next collation subject, as compared with the case of randomly selecting the collation order in the plural registered data, it becomes possible to improve the probability of reducing the collation number of times in case a person is a registrant. Even if the number of registered data becomes large, since the first degrees of similarity are not calculated at the time of collation, irrespective of the number of registered data, the probability can be improved.

Accordingly, it becomes possible to realize a collation method, a registration apparatus, a collation apparatus, and a program which can improve the processing efficiency in case a person is a registrant irrespective of the number of registered data, as compared with the case of randomly selecting the collation order in the plural registered data.

The nature, principle and utility of the invention will become more apparent from the following detailed description when read in conjunction with the accompanying drawings in which like parts are designated by like reference numerals or characters.

### BRIEF DESCRIPTION OF THE DRAWINGS

In the accompanying drawings:

FIG. 1 shows a schematic view indicative of the degrees of similarity between registered data used at the time of the collation, which is used to explain the collation method;

FIG. 2 shows a flowchart indicative the collation method;

FIG. 3 shows a schematic view indicative of the experimental result (1);

FIG. 4 shows a schematic view indicative of the experimental result (2);

FIG. 5 shows a schematic view indicative of the distribution of the collation number of times;

FIG. 6 shows a flowchart indicative the determination method;

FIG. 7 shows a schematic view indicative of the authentication system according to an embodiment of the present invention;

FIG. 8 shows a block diagram indicative of the configuration of a registration apparatus;

FIG. 9 shows a flowchart indicative of the registration processing procedure;

FIG. 10 shows a block diagram indicative of the configuration of a collation apparatus; and

FIG. 11 shows a flowchart indicative of the authentication processing procedure.

### DETAILED DESCRIPTION OF THE PREFERRED EMBODIMENTS

### (1) Collation Method

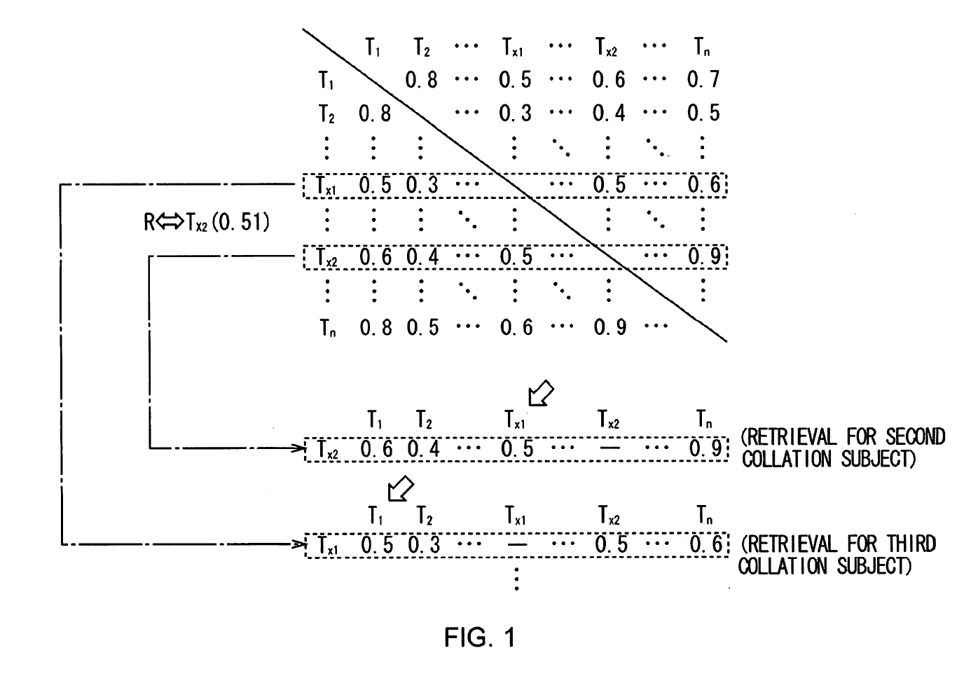

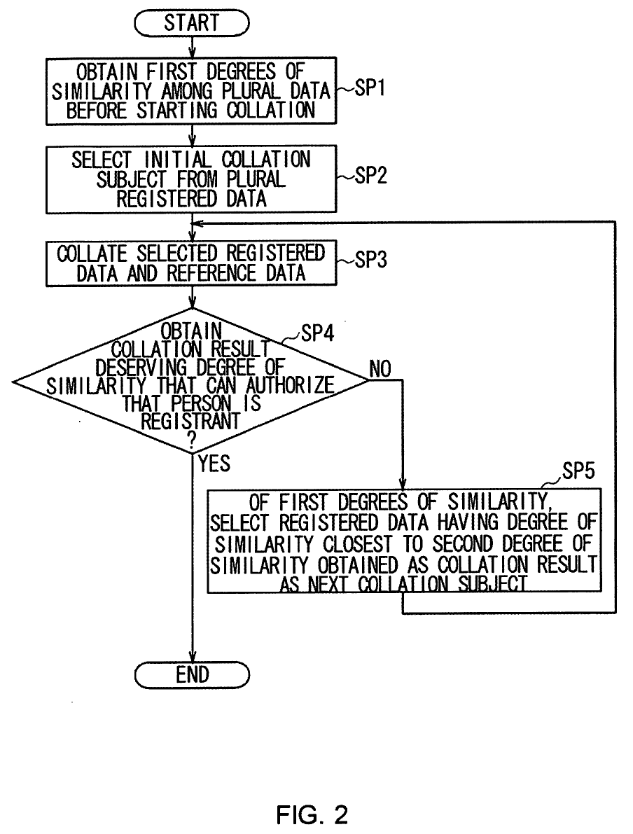

The collation method using registered data will be explained with reference to FIG. 1 and FIG. 2, in which it is assumed that the plural registered data is stored in a storage medium. In this collation method, in step SP1, before starting the collation, with respect to the plural registered data, the degrees of similarity among the data (referred to as first degrees of similarity, hereinafter) are obtained.

In FIG. 1, “T” represents registered data, and appended numbers “1 to n” represent the registration numbers, and the appended numbers “X1, X2” represent the middle registration numbers. Furthermore, respective numerical values in FIG. 1 represent the first degrees of similarity, in which the case of complete accordance is set to “1”. In FIG. 1, for the sake of convenience, the first degrees of similarity are lined up in the matrix direction in the order of registration.

In the state in which the first degrees of similarity are obtained, in case data (referred to as reference data, hereinafter) R to be collated with registered data is obtained, the collation is started.

That is, when the reference data R is obtained, in the collation method, in step SP2, of plural registered data T₁ to Tₙ, the registered data Tx₂ which is registered for the X2-th time is selected as initial collation subject, and in step SP3, this arbitrarily selected registered data Tx₂ and the reference data R are collated.

Then, in the collation method, in step SP4, it is determined whether or not the degree of similarity (referred to as second degree of similarity, hereinafter, and is “0.51” in FIG. 1) which is obtained as the collation result deserves the degree of similarity that can authorize that a person is a registrant.

In case a collation result which does not deserve a degree of similarity that can authorize that a person is a registrant is obtained (FIG. 2, step SP4 “NO”), in this collation method, in step SP5, of the degrees of similarity (degrees of similarity of X2 row, in FIG. 2) of the registered data Tx₂ being the collation subject at this time and other registered data T₁ to Tx₂₋₁, Tx₂₊₁ to Tₙ, the registered data Tx₁ corresponding to the degree of similarity “0.5” which is closest to the second degree of similarity “0.51” is selected as the next collation subject, and returning to step SP3, the registered data Tx₁ and reference data R are collated.

As the collation result, in step SP4, in case the second degree of similarity of the registered data Tx₁ and reference data R does not deserve a degree of similarity that can authorize that a person is a registrant (FIG. 2, step SP4 “NO”), in this collation method, in step SP5 again, excluding registered data Tx₂ which is collated as the collation subject in the past, among the degrees of similarity (degrees of similarity of X1 row, in FIG. 2) of the registered data Tx₁ being the collation subject and other registered data T₁ to Tx₁₋₁, Tx₁₊₁ to Tₙ, the T₁ corresponding to the degree of similarity “0.5” which is closest to the second degree of similarity “0.51” is selected as the next collation subject. In case there are plural registered data corresponding to the degree of similarity which is closest to the second degree of similarity in the first degrees of similarity, any one of the data is selected as next collation subject.

In this way, in the collation method, until the collation result (second degree of similarity) of one registered data set to the collation subject and the reference data deserve a degree of similarity that can authorize that a person is a registrant, of plural registered data, excluding registered data which is collated as the collation subject in the past, among the first degrees of similarity between one registered data set to the collation subject and other registered data other than the one registered data, registered data which has the degree of similarity closest to the second degree of similarity is selected as the next collation subject in series (FIG. 2, loop of step SP4-step SP5-step SP3).

In this way, in the collation method, in case it is assumed that reference data is any one of the plural registered data, since registered data which is close to the degree of similarity with the reference data is selected as the next collation subject, as compared with the case of randomly selecting the collation order in the plural registered data, the probability of reducing the collation number of times in case a person is a registrant is significantly improved.

Furthermore, in the collation method, the first degrees of similarity among the plural registered data are obtained before starting the collation. Accordingly, in the collation method, even if the number of registered data becomes large, since the first degrees of similarity are not calculated at the time of the collation, irrespective of the number of registered data, the probability is improved.

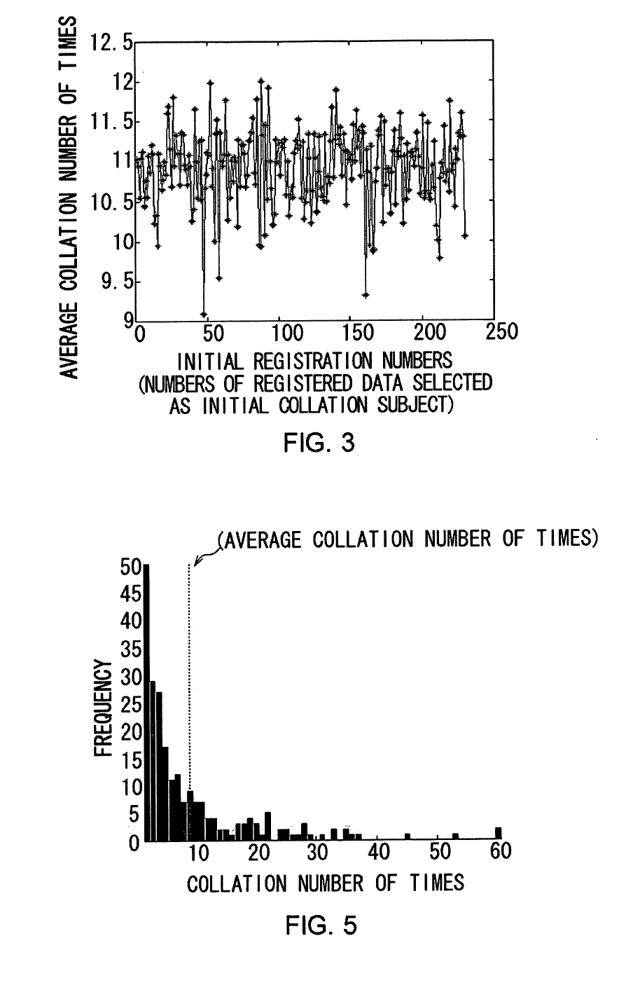

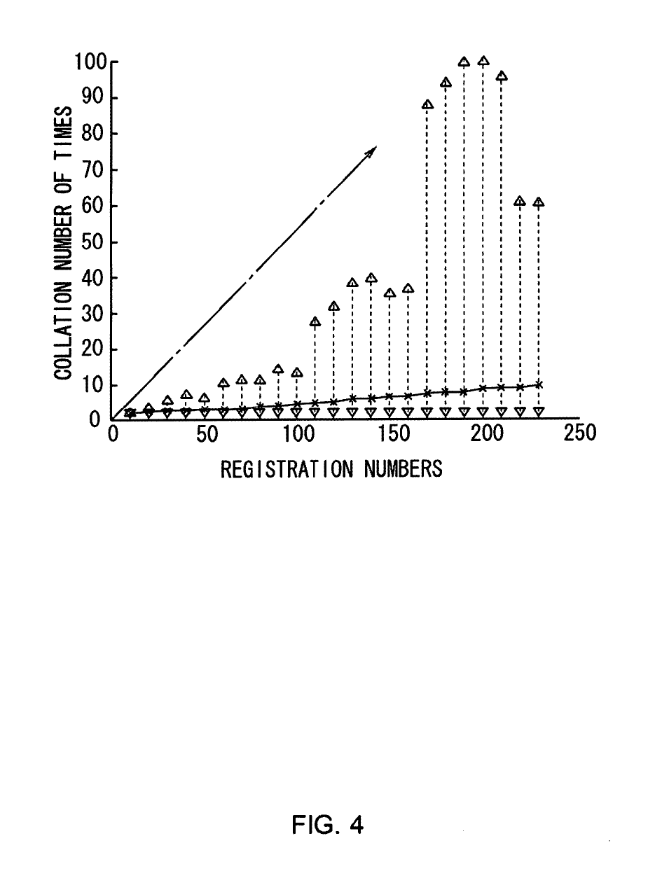

The experiment result related to the collation number of times in the collation method will be shown in FIG. 3 and FIG. 4. In FIG. 3 and FIG. 4, as plural registered data, images of blood vessel patterns of biological body region of 230 persons are employed.

In FIG. 3, in case of setting the registered data of 230 persons to initial collation subjects, with any one of other registered data other than the registered data being the initial collation subjects set to the reference data (data for searching), the average of the collation number of times when the other respective registered data is selected as the second collation subjects.

That is, in case of taking the case of setting the first registered data as the initial collation subject for example, of the remaining second to 230-th registered data, for example, 115-th registered data is set to the reference data arbitrarily. Then, the respective second to 230-th registered data is selected as the second collation subject, and, until the collation result (second degree of similarity) deserves a degree of similarity that can authorize that a person is a registrant, in accordance with the collation method, the third and following collation subjects are selected in series.

In this example, in case the 115-th registered data set to the reference data is selected as the second collation subject, the collation number of times comes to be two times, while in case the second to 230-th registered data excluding the 115-th registered data is selected as the second collation subject, the collation number of times comes to be three times or more. In this example, in case the first registered data is set to the initial collation subject, the average of the collation number of times comes to be 11 times.

As is apparent from FIG. 3, even if any of registered data is set to the initial collation subject, it can be seen that the collation number of times is approximately 9 to 12 times.

On the other hand, in FIG. 4, with registered data of multiples of 10 set to the total number, obtaining the average of the collation number of times in case the respective registered data is set to the initial collation subject, the maximum collation number of times and the minimum collation number of times in case the average of the collation number of times becomes minimum are shown. In FIG. 4, the average of the minimum collation number of times is shown by “×”, and the maximum collation number of times in case of taking the average of the minimum collation number of times is shown by “Δ”, and the minimum collation number of times is shown by “∇”, respectively, and the average of collation number of times in case of selecting the collation order in registered data of multiples of 10 randomly is shown by a chain line.

As is apparent from FIG. 4, even if the number of registered images is increased, the average of the collation number of times is significantly reduced as compared with the case of randomly selecting the collation order in registered images of multiples of 10.

On the other hand, when paying attention to the total number of 230 registered images, as is apparent from FIG. 5, most of the collation number of times is two or three, there may be a case in which a significantly much collation number of times (60 times at the maximum) is necessary as compared with the average (nine times) of the collation number of times. That is, in case the second degree of similarity is within a range in which the distribution of the first degrees of similarity among the registered images are congested, since many degrees of similarity close to the second degree of similarity exist, registered data which is roundabout consequently is selected in series as the next collation subject.

Accordingly, of the averages of the collation number of times, under the condition that the maximum number of times is less than a specified number, when the registered data that takes the minimum average is determined before starting the collation as one registered data that should be selected as the initial collation subject, the collation number of times when a person is a registrant can be totally reduced as compared with the case of randomly selecting the collation order in the plural registered data.

### (2) Determination Method in the Initial Collation Subject

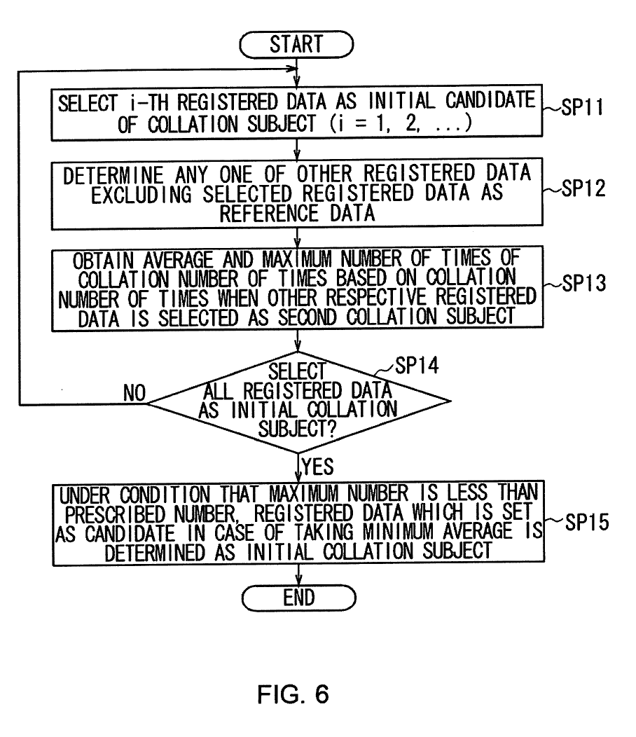

Specifically, the method to determine one registered data which should be selected as the initial collation subject will be explained with reference to FIG. 6.

According to the determination method, in step SP11, of plural registered data T₁ to Tₙ, i-th (i=1, 2, . . . , or n) registered data Tᵢ is selected as the initial candidate of the collation subject, and in step SP12, any one of the registered data Tₓ (x=1, 2, . . . , or n, where i≠x) of other registered data excluding the i-th registered data Tᵢ set to the initial candidate of the collation subject is determined as the reference data.

Then, according to the determination method, in step SP13, the average and the maximum number of times of the collation number of times when other respective registered data is selected as the second collation subject are obtained in accordance with the step SP3 to step SP5 in above described collation method.

That is, for example, in case the first registered data T₁ is selected as the initial collation subject, of other registered data T₂ to Tₙ excluding the registered data T₁, the second registered data T₂ is selected as the collation subject. Then, the registered data T₂ and the registered data Tₓ determined as the reference data are collated, and in case the collation result (second degree of similarity) does not deserve a degree of similarity that can authorize that a person is a registrant, until the collation result corresponding to the degree of similarity is obtained, in accordance with the step SP3 to step SP5 in above-described collation method, by selecting the third or following collation subject in series, the collation number of times when the registered data T₂ is selected as the second collation subject is obtained.

Furthermore, of other registered data T₂ to Tₙ, with respect to the remaining registered data T₃ to Tₙ, similar to the case of the registered data T₂, the collation number of times when selecting the registered data T₃ to Tₙ as the second collation subject is obtained. Then, based on the collation number of times when selecting the respective registered data T₂ to Tₙ as the second collation subject, the average and the maximum number of the collation number of times when the first registered data T₁ is selected as the candidate of the initial collation subject is obtained.

In this away, according to the determination method, until the positive result is obtained in step SP14, the average and the maximum number of times of the collation number of times when all the registered data T₁ to Tₙ are selected as the candidate of the initial collation subject are selected, and, then in step SP15, of the average of the collation number of times, under the condition that the maximum number is less than a prescribed number, the registered data which is set as the candidate in case of taking the minimum average is determined as the initial collation subject.

In this way, at the time of the collation, suppressing the maximum number, the collation number of times when a person is a registrant can be totally reduced as compared with the case of randomly selecting the collation order in the plural registered data.

On the other hand, employing the determination method, while the maximum number can be suppressed as compared with the case that does not employ this determination method, there may be a case in which the collation is ended through the maximum number of times. This is because the registered data is selected under the collation order in accordance with a predetermined rule (step SP3 to step SP5 in above described collation method).

### (3) Variation of Collation Method

Accordingly, in case of going through a collation number of times to some extent, in case of cutting off the predetermined rule, that is, in case of selecting the next collation subject at a predetermined number of times, when arbitrary selecting the collation subject excluding registered data collated as the collation subject in the past, the possibility of reducing the collation number of times until reaching the target registered data can be improved as compared with the case of not cutting off the predetermined rule.

Specifically, after the step SP4 in above-described collation method, a step of determining whether or not the number of times of selection for the next collation subject exceeds a prescribed number, and in case of exceeding the prescribed number, instead of the registered data selected as the next collation subject, excluding the registered data collated as the collation subject in the past, a step of arbitrarily reselecting one registered data is arranged.

It is desired that the prescribed number in the judging step is the average or lower than the collation number of times, and since the most of the collation number of times is two to three times (FIG. 5), “3” is more desirable.

In this way, in case of selecting the next collation subject at a predetermined number of times, when arbitrarily selecting the collation subject excluding registered data collated as the collation subject in the past, the collation number of times at the time of the collation can be suppressed.

### (4) Embodiments

Now, an embodiment employing the present invention will be explained referring to the following drawings.

### (4-1) Entire Configuration of the Authentication System

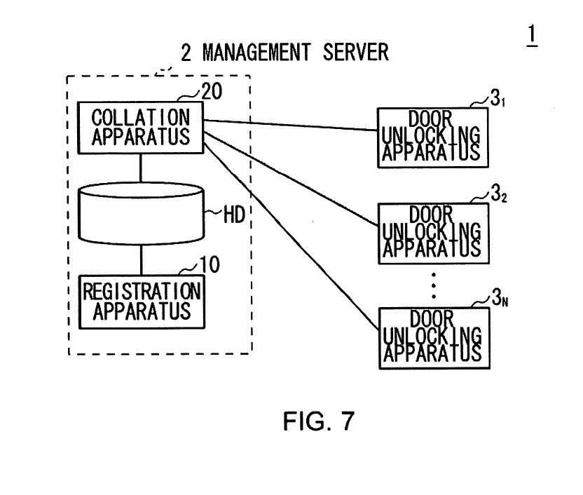

FIG. 7 shows an authentication system 1 according to an embodiment of the present invention. This authentication system 1 includes a management server 2, and door unlocking apparatuses 3₁ to 3_{N} arranged at plural doors which are connected to the management server 2 through dedicated lines.

A registration apparatus 10 of the management server 2 picks up an image of a blood vessel of a user to be registered (referred to as registrant, hereinafter), and extracts a blood vessel pattern in an image obtained as the image pickup result. Then, the registration apparatus 10 registers the image in which the blood vessel pattern is extracted in a storage medium HD as registered data by making the registered data correspond to data representing registration numbers.

Furthermore, every time registering the second or later registered data, a registration apparatus 3 obtains the first degrees of similarity among the plural registered data which is registered in the storage medium HD, and determines one registered data that should be selected as the initial collation subject. Then, the registration apparatus 3 stores data representing the first degrees of similarity and data representing the registration numbers in the registered data determined as the initial collation subject in the storage medium HD, or updates the data.

To a collation apparatus 20 of the management server 2, images in which the blood vessel pattern of a blood vessel of a user who wants to enter a room is extracted are input from the door unlocking apparatuses 3₁, 3₂, . . . , or 3_{N} as reference data. In case only registered data is stored in the storage medium HD, the collation apparatus 20 calculates the cross-correlation value between the input reference data and the registered data.

On the other hand, in case of two or more registered data is stored in the storage medium HD, using data representing the first degrees of similarity and data representing the registration numbers in the registered data which is determined as the initial collation subject, in accordance with a predetermined collation method, the collation apparatus 20 calculates the cross-correlation value between the input reference data and two or more registered data.

Furthermore, in case a cross-correlation value which is more than a threshold value is obtained in a collation term prescribed in advance, the collation apparatus 20 sends data authorizing that a person is a registrant to the door unlocking apparatuses 3₁, 3₂, . . . , or 3_{N} which sent the reference data. On the other hand, in case of not obtaining a cross-correlation value which is more than a predetermined threshold value, the collation apparatus 20 sends data which does not authorize that a person is a registrant to the door unlocking apparatuses 3₁, 3₂, . . . , or 3_{N} which sent the reference data.

The door unlocking apparatuses 3₁, 3₂, . . . , or 3_{N} pick up an image of a blood vessel of a user who wants to enter a room, and extracts blood vessel pattern in the image obtained as the image pickup result. Then, the door unlocking apparatuses 3₁, 3₂, . . . , or 3_{N} send the image in which the blood vessel pattern is extracted to the collation apparatus 20 of the management server 2 as reference data, and waits for data authorizing that a person is a registrant or data which does not authorize that a person is a registrant.

In case of receiving data authorizing that a person is a registrant from the collation apparatus 20, the door unlocking apparatuses 3₁, 3₂, . . . , or 3_{N} unlock the door, while in case of receiving data which does not authorize that a person is a registrant from the collation apparatus 20, the door unlocking apparatuses 3₁, 3₂, . . . , or 3_{N} keep the door locked.

In this way, the authentication system 1 can make only a registrant open and close the door.

### (4-2) Configuration of the Registration Apparatus

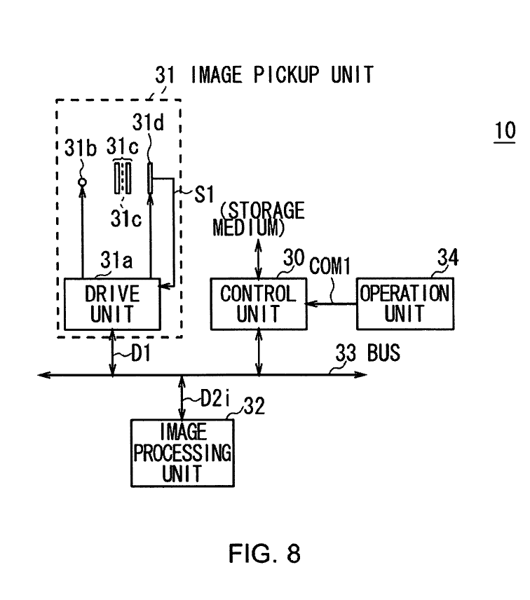

Next, the configuration of the registration apparatus 10 will be explained. As shown in FIG. 8, the registration apparatus 10 includes a control unit 30, and an image pickup unit 31 and an image processing unit 32 are connected to the control unit 30 through a bus 33.

The control unit 30 is configured by a microcomputer that includes a central processing unit (CPU) that controls the entire registration apparatus 10, a read only memory (ROM) that has stored therein various programs and set up information, and a random access memory (RAM) that works as a work memory of the CPU.

When an execution command COM1 for a mode (referred to as blood vessel registration mode, hereinafter) for registering a blood vessel of a registrant is given from an operation unit 34, the control unit 30 arbitrarily controls the image pickup unit 31 and the image processing unit 32 in accordance with programs stored in the ROM to execute the registration processing.

The image pickup unit 31 picks up an image of a blood vessel under the control of the control unit 30. That is, in case of receiving an image pickup start command from the control unit 30, a drive unit 31a drives a near-infrared ray light source 31b to irradiate a near-infrared ray to a predetermined image pickup position, and adjusts the diaphragm value of a diaphragm 31c and the shutter speed (exposure time) with respect to an image pickup element 31d based on an exposure value (EV) supplied from the control unit 30.

In this embodiment, as the image pickup subject, a blood vessel of a finger is employed, and, in case a finger is arranged at an image pickup position, a near-infrared ray irradiated from the near-infrared ray light source 31b to the finger passes through the inside of the finger to be reflected and scattered therein, and goes into the image pickup element 31d through an optical system 31e as blood vessel projection light that projects a blood vessel. In this case, due to the photoelectric conversion by the image pickup element 31d, an image signal S1 of the blood vessel is generated to be supplied to the drive unit 31a.

The drive unit 31a performs the analog/digital (A/D) conversion processing for the image signal S1, and sends image data D1 obtained as the processing result to the image processing unit 32.

In this way, the image pickup unit 31 picks up an image of a blood vessel under the control of the control unit 30.

The image processing unit 32 extracts the blood vessel pattern in the image of the image data D1, and sends image data D2ᵢ (i=1, 2, . . . , or n) obtained as the extraction result of the blood vessel pattern to the control unit 30.

As a specific extraction method for a blood vessel pattern, the image processing unit 32 cuts out a part including the blood vessel pattern of an image, and extracts the contour of the blood vessel pattern in thus cut out image. Then, the image processing unit 32 binarizes the image in which the contour of the blood vessel pattern is extracted, and thins the blood vessel pattern in thus binarized image.

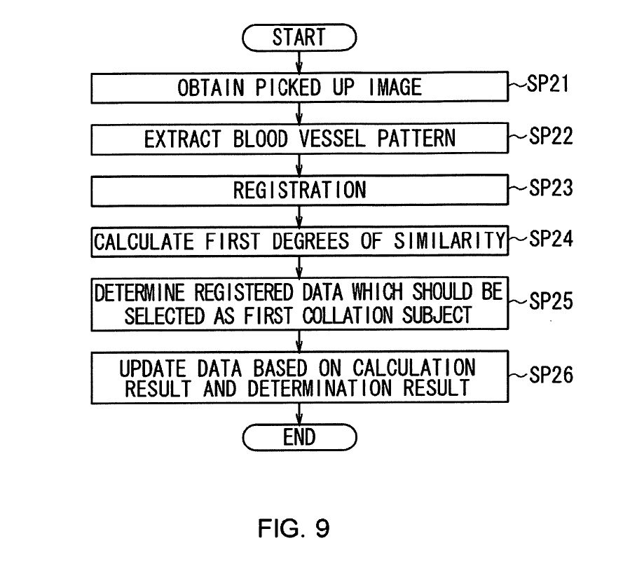

The registration processing of the control unit 30 in case of registering the second registered data or later in the storage medium HD will be explained using a flowchart shown in FIG. 9.

When receiving the execution command COM1 for the blood vessel registration mode from an operation unit 36, in step SP21, the control unit 30 controls the image pickup unit 31 to pick up an image of a blood vessel, and obtains an image (image data D1 (FIG. 8)) generated as the result of the image pickup by the image pickup unit 31.

Next, in the step SP22, the control unit 30 controls the image processing unit 32 such that a blood vessel pattern in the image is extracted, and in the next step SP23, registers an image (image data D2ᵢ (FIG. 8)) obtained as the extraction result for the blood vessel pattern in the image processing unit 32 by storing the image in the storage medium HD as the registered data.

Next, in step SP24, with respect to two or more registered data stored in the storage medium HD, the control unit 30 calculates the cross-correlation values among the data as the first degrees of similarity, and in the step SP25, after going through the processing steps similar to the respective steps from the step SP11 to step SP15 in above-described determination method (FIG. 6), determines registered data which should be selected as the first collation subject.

Finally, in step SP26, the control unit 30 updates the contents of data representing the first degrees of similarity stored in the storage medium HD to the first degrees of similarity calculated in the step SP24, and updates the contents of data representing the registration numbers in the registered data determined as the initial collation subject to the registration numbers in the registered data determined in step SP25, and ends the registration processing.

In this way, every time registering the second registered data or later, the control unit 30 updates data representing the first degrees of similarity among the plural registered data registered in the storage medium HD, and data representing the registration numbers in the registered data determined as the initial collation subject.

In case of registering the first registered data in the storage medium HD, the control unit 30 goes through only the respective steps from the step SP21 to step SP23 to execute the registration processing.

### (4-3) Configuration of the Collation Apparatus

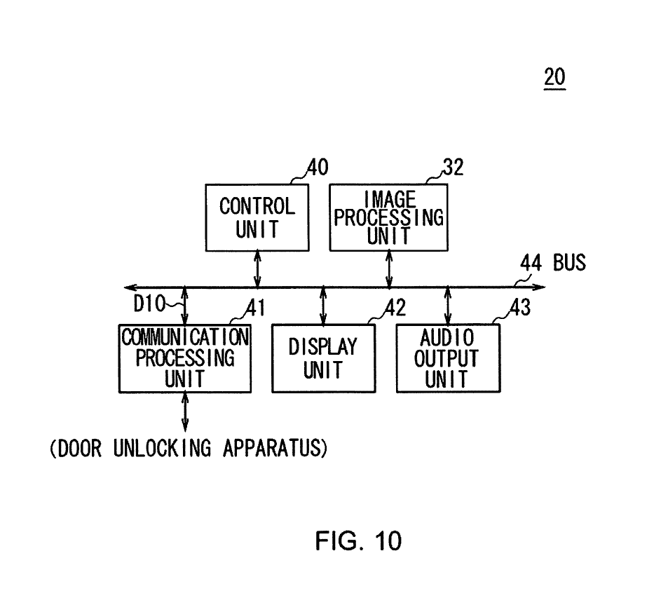

On the other hand, as shown in FIG. 10 in which the same reference numerals are appended to parts corresponding to the parts in FIG. 8, the collation apparatus 20 includes a control unit 40, and the image processing unit 32, a communication processing unit 41, a display unit 42, and an audio output unit 43 are connected to the control unit 40 through a bus 44.

The control unit 40 is configured by a microcomputer that includes a central processing unit (CPU) that controls the entire collation apparatus 20, a read only memory (ROM) that has stored therein various programs and set up information, a random access memory (RAM) that works as a work memory of the CPU, a timer.

When image data D10 as the image pickup result in the door unlocking apparatuses 3₁, 3₂, . . . , or 3_{N} is given from the communication processing unit 41, in accordance with programs stored in the ROM, the control unit 40 arbitrarily controls the image processing unit 32, communication processing unit 41, display unit 42, and audio output unit 43 to execute the authentication processing.

The communication processing unit 41 performs the mutual authentication with the door unlocking apparatuses 3₁, 3₂, . . . , or 3_{N} (FIG. 1) which outputs the image data D10, and various data is sent and received among the door unlocking apparatuses 3₁, 3₂, . . . , or 3_{N} for which the mutual authentication is performed and control unit 40.

The display unit 42 displays the contents represented by display data supplied from the control unit 40 on a display screen, and the audio output unit 43 outputs the contents represented by audio data supplied from the control unit 40 from loudspeakers.

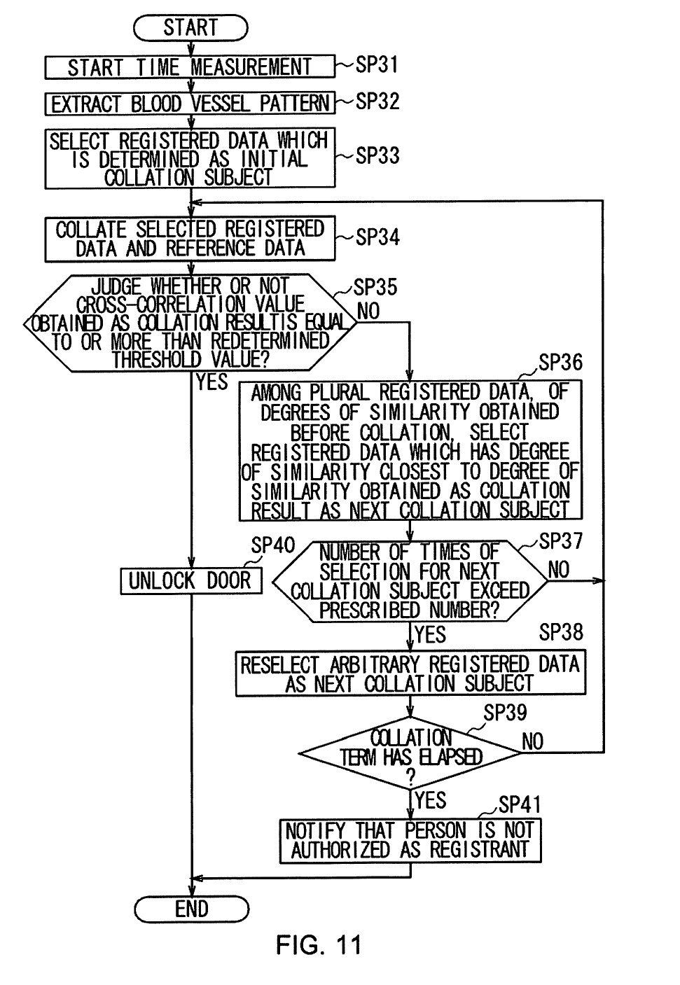

Next, the authentication processing by the control unit 40 will be explained using a flowchart shown in FIG. 11.

When receiving the image data D10 from the communication processing unit 41, in step SP31, the control unit 40 starts the time measurement, and, then in step SP32, controls the image processing unit 32 to extract a blood vessel pattern in an image, and obtains data (reference data) of an image in which the blood vessel pattern is extracted.

Next, in step SP33, the control unit 40 selects registered data which is determined as the initial collation subject, and then in step SP34, similar to above-described step SP3 (FIG. 1), collates thus selected registered data D2, and the reference data D10 by the cross-correlation, and, then in step SP35, similar to above-described step SP4 (FIG. 1), judges whether or not the cross-correlation value (second degree of similarity) obtained as the collation result is equal to or more than a predetermined threshold value.

In case a cross-correlation value (second degree of similarity) less than a predetermined threshold value is obtained, the control unit 40 does not authorize that a person is a registrant, and, in the next step SP36, similar to above-described step SP5 (FIG. 1), excluding registered data which is collated as the collation subject in the past, among the registered data D2ᵢ set to the collation subject and cross-correlation values with other registered data (that is, first degrees of similarity: for example corresponding to respective values in X1 row in FIG. 2), selects registered data which has a cross-correlation value closest to the cross-correlation value between the registered data D2, set to the collation subject and the reference data D10 (that is, second degree of similarity: corresponding to “0.51” in FIG. 2) as the next collation subject.

Then, in step SP37, the control unit 40 judges whether or not the number of times of selection for the next collation subject exceeds a prescribed number, and, in case of exceeding the prescribed number, instead of the registered data which is selected as the next collation subject, reselects arbitrary registered data as the next collation subject, and, after setting the value of the number of times of selection to an initial value, goes to the next step SP38.

On the other hand, in case the number of times of selection for the next collation subject does not exceed a prescribed number, without reselecting arbitrary registered data, after incrementing the value of the number of times of selection by “1”, the control unit 40 goes to the next step SP39. In the step SP38, until it is determined that a predetermined collation term has elapsed, the control unit 40 returns to the step SP34 to repeat above-described processing.

In this way, in the collation term, until the cross-correlation value (second degree of similarity) between one registered data set to the collation subject and reference data reaches a value that can authorize that a person is a registrant, from among plural registered data, excluding registered data which is collated as the collation subject in the past, the control unit 40 selects one registered data which should be the next collation subject in accordance with a predetermined rule (that is, step SP36) or arbitrarily.

On the other hand, in case a cross-correlation value (second degree of similarity) which is equal to or more than a predetermined threshold value is obtained before the collation term has elapsed, the control unit 40 authorizes that a person is a registrant, and, going to step SP40, through the door unlocking apparatuses 3₁, 3₂, . . . , or 3_{N} (FIG. 1) which outputs the reference data D10, unlocks a corresponding door, ending the authentication processing.

On the other hand, in case the collation term has elapsed without obtaining a cross-correlation value (second degree of similarity) which is equal to or more than a predetermined threshold value, the control unit 40 authorizes that a person is a third party, and, going to step SP41, through the display unit 42 (FIG. 1) and audio output unit 43 (FIG. 1), notifies that a person is not authorized as a registrant visually and auditorily, ending the authentication processing.

### (5) Other Embodiments

In above-described embodiments, as registered data stored in a storage medium, an image of a blood vessel pattern is employed, to which the present invention is not restricted, and images of various biological patterns such as a fingerprint, a mouthprint, a nerve may be employed, and a feature point such as a branch point or edge point of biological patterns may be employed, and furthermore, the present invention may be employed to a secret number etc. other than the biological patterns.

Furthermore, in above-described embodiments, the cross-correlation value is employed as the first degrees of similarity and second degree of similarity, to which the present invention is not restricted, and other various criteria representing the degrees of similarity may be employed.

Moreover, in above-described embodiments, in case of selecting the collation subject at a predetermined number of times, excluding registered data collated as the collation subject in the past, the collation subject is selected arbitrarily. On the other hand, instead of this, within a predetermined range with the second degree of similarity being the criterion, from among the first degrees of similarity between one registered data set to the collation subject at that time and other registered data, in case there is registered data having a degree of similarity closest to the second degree of similarity by a number equal to or more than a prescribed number, excluding registered data collated as the collation subject in the past, the next collation subject may be arbitrarily selected.

Specifically, in above-described step SP36 (FIG. 11), from among the first degrees of similarity between one registered data set to the collation subject at that time and other registered data, registered data which is within a predetermined range with the second degree of similarity being the criterion is detected, and in step SP37, it is judged whether or not the number of thus detected registered data is equal to or more than a prescribed number.

Then, in case the number of the registered data is equal to or more than a prescribed number, in step SP38, excluding registered data collated as the collation subject in the past, the next collation subject is arbitrarily selected, returning to step SP34 to repeat above-described processing. On the other hand, in case the number of the registered data is less than a prescribed number, of registered data detected in the step SP36, one registered data which is closest to the second degree of similarity is selected as the next collation subject, returning to step SP34 to repeat above-described processing.

In this way, in case of selecting the collation subject at a predetermined number of times, similar to the case in which, excluding registered data collated as the collation subject in the past, the collation subject is selected arbitrarily, the probability of reducing the collation number of times before reaching the target registered data can be improved.

Yet moreover, in above-described embodiments, one registered data which should be selected as the initial collation subject is determined every time registered data is registered, to which the present invention is not restricted, and registered data may be determined every time 100 registered data is registered, and registered data may be determined every time registered data of a prescribed number is registered in a storage medium.

Yet moreover, in above-described embodiments, the registration processing (FIG. 9) and authentication processing (FIG. 11) are executed in accordance with a program expanded on the RAM from the ROM, to which the present invention is not restricted, and the registration processing and authentication processing may be executed in accordance with a program installed from a storage medium such as a compact disc (CD), digital versatile disc (DVD), a semiconductor memory, etc., or a program downloaded from the Internet.

Yet moreover, in above-described embodiments, for the collation function and registration function, single apparatuses are used respectively, to which the present invention is not restricted, and a single apparatus may be provided with the collation function and registration function, or a single apparatus provided with the image pickup function may be separated, that is, various configurations may be employed according to the use applications.

Yet moreover, in above-described embodiments, as the effect when a person is authorized as a registrant, a door is unlocked, to which the present invention is not restricted, and there may be employed an effect of releasing a function which is restricted in advance, or an effect of changing the state to the unusable state to the usable state, or other effects. The configuration of the authentication system may be arbitrarily changed depending on the difference of the effect.

The present invention can be applied to the biometrics authentication.

It should be understood by those skilled in the art that various modifications, combinations, sub-combinations and alterations may occur depending on design requirements and other factors insofar as they are within the scope of the appended claims or the equivalents thereof.

What is claimed is:

1. A collation method comprising:
a first step of, with respect to plural registered data stored in a storage medium, calculating first degrees of similarity among the data before stating the collation;
a second step of, of the plural registered data, calculating a second degree of similarity between one registered data selected as the collation subject and reference data to be collated with the one registered data; and
a third steep of, in case the second degree of similarity is not a degree of similarity that can authorize that a person is a registrant, of other registered data other than the one registered data, excluding registered data which is collated as the collation subject in the past, of the first degrees of similarity among the one registered data and other registered data, selecting one registered data having a degree of similarity closest to the second degree of similarity as the next collation subject.

2. The collation method according to claim 1, wherein
in the third step, in a predetermined range with the second degree of similarity being the criterion, among the first degrees of similarity between the one registered data and other registered data, in case the number of the degree of similarity closest to the second degree of similarity is equal to or more than a prescribed number, excluding registered data which is collated as the collation subject in the past, the next collation subject is arbitrarily selected.

3. The collation method according to claim 1, wherein
in the third step, in case the next collation subject is selected at a predetermined number of times, excluding registered data which is collated as the collation subject in the past, the next collation subject is arbitrarily selected.

4. The collation method according to claim 1, further comprising:
a determination step of determining one registered data that should be selected as an initial collation subject before stating the collation, wherein
in the determination step, in case the respective plural registered data is set to the candidate of the initial collation subject, with any of other registered data other than one registered data being the candidate of the initial collation subject set to the reference data, the average and the maximum number of times of the collation number of times when the other respective registered data is selected as the second collation subject is obtained, and
of the average of the respective collation number of times obtained in case the respective plural registered data is set to the candidate of the initial collation subject, registered data which is set to the candidate in case of taking the minimum average when the maximum number of times of the collation number of times is less than a prescribed number is determined as one registered data that should be selected as the initial collation subject.

5. The collation method according to claim 3, wherein
in the determination step,
one registered data that should be selected as the initial collation subject is determined every time the registered data of the prescribed number is registered in the storage medium.

6. A registration apparatus comprising:
a calculation unit that, with respect to plural registered data stored in a storage medium, calculates first degrees of similarity among the data as the selection criterion when one registered data is selected from among the plural registered data in a predetermined collation method,
a storage control unit that controls the storage medium such that the first degrees of similarity calculated by the calculation unit is stored in the storage medium.

7. The registration apparatus according to claim 6, wherein
in the collation method, until a second degree of similarity between one registered data selected as the collation subject and reference data to be collated with the one registered data comes to be a degree of similarity that can authorize that a person is a registrant, of the plural registered data, excluding registered data which is collated as the collation subject in the past, of the first degrees of similarity among the one registered data and other registered data other than the one registered data, one registered data having a degree of similarity closest to the second degree of similarity is selected as the next collation subject.

8. The registration apparatus according to claim 6, further comprising:
a determination unit that determines one registered data that should be selected as an initial collation subject in the collation method, wherein
the storage control unit controls the storage medium such that the first degrees of similarity and an identifier of one registered data which is determined in the determination unit in the storage medium.

9. The registration apparatus according to claim 7, wherein
in case the respective plural registered data is set to the candidate of the initial collation subject, with any of other registered data other than one registered data being the candidate of the initial collation subject set to data to be retrieved, the determination unit obtains the average and the maximum number of times of the collation number of times which is collated in the collation method when the other respective registered data is selected as the second collation subject, and
of the average of the respective collation number of times obtained in case the respective plural registered data is set to the candidate of the initial collation subject, determines registered data which is set to the candidate in case of taking the minimum average when the maximum number of the collation number of times is less than a prescribed number as one registered data that should be selected as the initial collation subject.

10. A collation apparatus comprising:
a calculation unit that, of the plural registered data stored in a storage medium, calculates a second degree of similarity between one registered data selected as the collation subject and reference data to be collated with the one registered data; and
a selection unit that, in case the second degree of similarity is not a degree of similarity that can authorize that a person is a registrant, of other registered data other than the one registered data, excluding registered data which is collated as the collation subject in the past, among the first degrees of similarity between the plural registered data stored in the storage medium, of the first degrees of similarity among the one registered data and other registered data, selects one registered data having a degree of similarity closest to the second degree of similarity as the next collation subject.

11. The collation apparatus according to claim 10, wherein
in a predetermined range with the second degree of similarity being the criterion, among the first degrees of similarity between the one registered data and other registered data, in case the number of registered data which has the degree of similarity closest to the second degree of similarity is equal to or more than a prescribed number, excluding registered data which is collated as the collation subject in the past, the selection unit arbitrarily selects the next collation subject.

12. The collation apparatus according to claim 10, wherein
in case the next collation subject is selected at a predetermined number of times, excluding registered data which is collated as the collation subject in the past, the selection unit arbitrarily selects the next collation subject.

13. A program that makes a computer execute the steps of:
with respect to plural registered data stored in a storage medium, calculating first degrees of similarity among the data as selection criterion when one registered data is selected from among the plural registered data in a predetermined collation method; and
controlling the storage medium such that the first degrees of similarity are stored in the storage medium.

14. A program that makes a computer execute the steps of:
of the plural registered data stored in a storage medium, calculating a second degree of similarity between one registered data selected as the collation subject and reference data to be collated with the one registered data; and
in case the second degree of similarity is not a degree of similarity that can authorize that a person is a registrant, of other registered data other than the one registered data, excluding registered data which is collated as the collation subject in the past, among the first degrees of similarity between the plural registered data stored in the storage medium, of the first degrees of similarity among the one registered data and other registered data, selecting one registered data having a degree of similarity closest to the second degree of similarity as the next collation subject.
